(19) United States
(12) Patent Application Publication
(10) Pub. No.: US 2008/0120713 A1
(43) Pub. Date: May 22, 2008

(54) Modem and certificate selection method thereof

(75) Inventors: Yew-Min Lo, Tu-Cheng (TW); Lu-Meng Hsu, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: Hon Hai Precision Industry Co., LTD.

(21) Appl. No.: 11/647,731

(22) Filed: Dec. 29, 2006

(30) Foreign Application Priority Data
Nov. 17, 2006 (CN) 200610156909.1

(51) Int. Cl. H04L 9/32

(52) U.S. Cl. 726/10

(57) ABSTRACT

A modem (10) includes a locking module (100), a bandwidth selection module (220), and an authentication module (300). The locking module locks a bandwidth. The bandwidth selection module determines whether the locked bandwidth is a predefined bandwidth, and selects a type of certificate from a plurality of types of certificates according to the determined result. The authentication module employs the selected type of certificate for authentication. A certificate selection method thereof is also provided.

### BACKGROUND OF THE INVENTION

1. Field of the Invention

The invention relates to network communications, and particularly to a modem and a certificate selection method.

2. Description of Related Art

With developments in network communication technologies, cable modems have become widely used. Generally, standards of cable modems include a data over cable service interface specifications (DOCSIS) standard and a European DOCSIS (Euro-DOCSIS) standard. The DOCSIS standard is mainly for standardizing cable modems in North America, and the Euro-DOCSIS standard is mainly for standardizing cable modems in Europe.

However, conventional cable modems only support a United States (US) certificate or a Euro certificate, and employ the supported certificate for baseline privacy interface (BPI) authentication. Accordingly, the conventional cable modems operate in only one of a US environment and a Euro environment, and do not support different types of certificates.

With market integration of the cable modems, what is needed is a dual mode cable modem which can simultaneously support a US certificate and a Euro certificate and operates in both a US environment and a European environment. However, how to automatically and simply select one type of certificate from a plurality of types of certificates for BPI authentication is difficult for designers of the dual mode cable modem.

### SUMMARY OF THE INVENTION

An exemplary embodiment of the present invention provides a modem. The modem includes a locking module, a bandwidth selection module, and an authentication module. The locking module locks a bandwidth. The bandwidth selection module determines whether the locked bandwidth is a predefined bandwidth, and selects a type of certificate from a plurality of types of certificates according to the determined result. The authentication module employs the selected type of certificate for authentication.

Another exemplary embodiment of the present invention provides a certificate selection method. The certificate selection method includes: locking a bandwidth; determining whether the locked bandwidth is a predefined bandwidth; and selecting a type of certificate corresponding to the predefined bandwidth from a plurality of types of certificates if the locked bandwidth is the predefined bandwidth.

Other advantages and novel features will become more apparent from the following detailed description when taken in conjunction with the accompanying drawings, in which:

### BRIEF DESCRIPTION OF THE DRAWINGS

FIG. 1 is a schematic diagram of a network communication system of an exemplary embodiment of the present invention;

FIG. 2 is a schematic diagram of functional modules of a modem of another exemplary embodiment of the present invention;

FIG. 3 is a flowchart of a certificate selection method of a further exemplary embodiment of the present invention; and

FIG. 4 is a flowchart of a certificate selection method of a still further exemplary embodiment of the present invention.

### DETAILED DESCRIPTION OF THE INVENTION

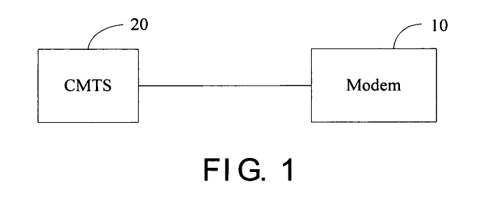

FIG. 1 is a schematic diagram of a network communication system of an exemplary embodiment of the present invention. In the exemplary embodiment, the network communication system includes a data communication device like a cable modem 10 and a cable modem terminal system (CMTS) 20. The modem 10 may be a dual mode cable modem, and includes a plurality of types of certificates to operate the modem 10, such as a United States (US) certificate and a Europe (Euro) certificate.

The CMTS 20 may be assumed as a US CMTS or a Euro CMTS. The CMTS 20 transmits a downstream signal to the modem 10 via a downstream channel. If the CMTS 20 is a US CMTS, a bandwidth of the downstream channel is 6 MHz. If the CMTS 20 is a Euro CMTS, a bandwidth of the downstream channel is 8 MHz.

In most circumstances, the US CMTS 20 uses a US certificate, and the Euro CMTS 20 uses a Euro certificate. In such case, the modem 10 selects a US certificate for authenticating the US CMTS 20, and selects a Euro certificate for authenticating the Euro CMTS 20.

However, in some circumstances, during the transition from a US CMTS to a Euro CMTS, the US CMTS and the Euro CMTS may coexist in one company. In order to maintain the same type of certificate, the US CMTS and the Euro CMTS may use the same type of certificate. That is, both the US CMTS and the Euro CMTS use the US certificate or the Euro certificate. Therefore, the US CMTS 20 may use the Euro certificate, or the Euro CMTS 20 may use the US certificate. In such case, the modem 10 may select the Euro certificate for authenticating the US CMTS 20, or select the US certificate for authenticating the Euro CMTS 20.

In the exemplary embodiment, the modem 10 selects a type of certificate from a plurality of types of certificates for authenticating the CMTS 20 according to a locked bandwidth. In detail, the modem 10 initially receives the downstream signal from the CMTS 20, and locks a bandwidth by locking the downstream signal, and also determines whether the locked bandwidth is a predefined bandwidth. If the locked bandwidth is the predefined bandwidth, the modem 10 selects a type of certificate corresponding to the predefined bandwidth from the plurality of types of certificates. Otherwise, the modem 10 selects a type of certificate not corresponding to the predefined bandwidth from the plurality of types of certificates.

In this embodiment, if the predefined bandwidth is 6 MHz, the type of certificate corresponding to the predefined bandwidth is the US certificate, and the type of certificate not corresponding to the predefined bandwidth is the Euro certificate. If the predefined bandwidth is 8 MHz, the type of certificate corresponding to the predefined bandwidth is the Euro certificate, and the type of certificate not corresponding to the predefined bandwidth is the US certificate.

Then, the modem 10 employs the selected type of certificate for baseline privacy interface (BPI) authentication. If authorization is successful, the modem 10 moves to an authorized state. If authorization is unsuccessful, the modem 10 selects another type of certificate from the plurality of types of certificates for BPI authentication.

Therefore, the modem 10 automatically and simply selects an appropriate type of certificate for BPI authentication, so communication safety is maintained.

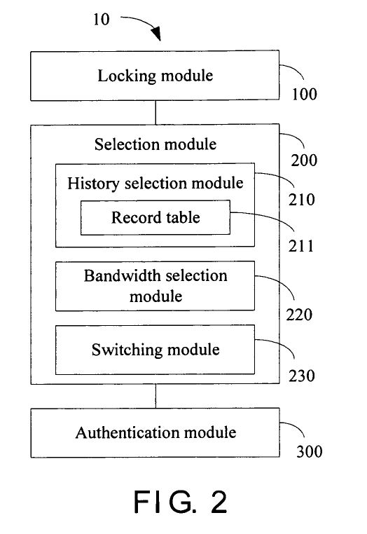

FIG. 2 is a schematic diagram of functional modules of a modem 10 of an exemplary embodiment of the present invention. In the exemplary embodiment, the modem 10 includes a locking module 100, a selection module 200, and an authentication module 300. The selection module 200 includes a history selection module 210, a bandwidth selection module 220, and a switching module 230.

In other embodiments, the modem 10 may directly include the locking module 100, the history selection module 210, the bandwidth selection module 220, the switching module 230, and the authentication module 300.

The locking module 100 locks attributes of a channel, for example, a frequency and a bandwidth of the channel. In the exemplary embodiment, the locking module 100 locks the frequency and the bandwidth of the channel by locking a downstream signal of the channel. For example, the locking module 100 sequentially scans the downstream channels with center frequencies from 93 MHz to 858 MHz at a bandwidth interval of 6 MHz or 8 MHz to determine whether a downstream signal therein is locked. That is, the locking module 100 receives downstream signals in the above downstream channels, and then determines whether quadrature amplitude modulation (QAM) signals, forward error correction (FEC) patterns, and synchronization (SYN) packets of the downstream signals are obtained. If a QAM signal, a FEC, and a SYN packet of a downstream signal are obtained, the locking module 100 successfully locks the downstream signal. When the locking module 100 locks the downstream signal, the downstream channel transmitting the downstream signal has been locked. The frequency and the bandwidth locked by the locking module 100 are respectively the center frequency and the bandwidth of the locked downstream channel.

In other embodiments, the locking module 100 may first scan the downstream channels with center frequencies from 93 MHz to 858 MHz at a bandwidth interval of 6 MHz, and then scan the downstream channels with center frequencies from 93 MHz to 858 MHz at a bandwidth interval of 8 MHz, in order to determine whether a downstream channel is locked. It should be noted that the method for locking the downstream channels, namely the method for locking the frequency and the bandwidth, is not restricted.

The history selection module 210 includes a record table 211. The record table 211 includes a plurality of recorded entries of previously successful authorizations. Each entry includes a frequency field, a bandwidth field, and a certificate field. For example, a format of an entry may be “frequency-bandwidth-certificate”. The frequency field indicates a previously locked frequency, the bandwidth indicates a previously locked bandwidth, and the certificate field indicates a previously selected certificate. For example, an entry is “399-8M-Euro certificate”, indicating that a previously locked frequency was 399 MHz, a previously locked bandwidth was 8 MHz, and a previously selected certificate was a Euro certificate.

The history selection module 210 searches the record table 211 according to the frequency and the bandwidth locked by the locking module 100, and determines whether a matching entry is found in the record table 211, and also selects a type of certificate according to the matching entry. In the exemplary embodiment, the history selection module 210 compares the locked frequency and the locked bandwidth with each entry in the record table 211 to determine whether a matching entry is found. If an entry with a frequency and a bandwidth the same as the locked frequency and the locked bandwidth is found in the record table 211, the matching entry is considered found. In such case, the history selection module 210 selects a type of certificate according to the matching entry, namely according to the certificate field of the entry.

If no entry with a frequency and a bandwidth the same as the locked frequency and the locked bandwidth is found in the record table 211, no matching entry is considered found. In such case, the bandwidth selection module 220 selects a type of certificate from the plurality of types of certificates according to the bandwidth locked by the locking module 100. In the exemplary embodiment, the bandwidth selection module 220 determines whether the locked bandwidth is a predefined bandwidth, and then selects a type of certificate according to the determination. If the locked bandwidth is the predefined bandwidth, the bandwidth selection module 220 selects a type of certificate corresponding to the predefined bandwidth. If the locked bandwidth is not the predefined bandwidth, the bandwidth selection module 220 selects a type of certificate not corresponding to the predefined bandwidth.

In the exemplary embodiment, if the predefined bandwidth is 6 MHz, the type of certificate corresponding to the predefined bandwidth is a US certificate, and the type of certificate not corresponding to the predefined bandwidth is a Euro certificate. If the predefined bandwidth is 8 MHz, the type of certificate corresponding to the predefined bandwidth is a Euro certificate, and the type of certificate not corresponding to the predefined bandwidth is a US certificate.

The authentication module 300 employs the type of certificate selected by the history selection module 210 or the bandwidth selection module 230 for authentication. In the exemplary embodiment, the authentication module 300 employs the selected type of certificate for BPI authentication. That is, the authentication module 300 transmits an authorization request packet to the CMTS 20. The authorization request packet includes the selected type of certificate.

In the exemplary embodiment, if authorizing the modem 10, the CMTS 20 transmits an authorization reply packet to the modem 10. If not authorizing the modem 10, the CMTS 20 transmits an authorization reject packet to the modem 10.

The authentication module 300 also determines whether the authorization is successful. In the exemplary embodiment, the authentication module 300 determines whether the authorization is successful according to a received response packet from the CMTS 20. If receiving the authorization reply packet from the CMTS 20, the authentication module 300 determines the authorization is successful. Then the history selection module 210 updates the record table 211 according to the successful authorization information. Afterwards, the modem 10 moves to a BPI authorized state.

If receiving the authorization reject packet from the CMTS 20, the authentication module 300 determines the authorization is unsuccessful.

The switching module 230 determines whether all types of certificates have been tried when the authorization is unsuccessful, and selects an untried type of certificate. Then the authentication module 300 employs the type of certificate selected by the switching module 230 for authentication again, until the authorization is successful or all types of certificates have been tried.

If all types of certificates have been tried, the modem 10 moves to a BPI silent state.

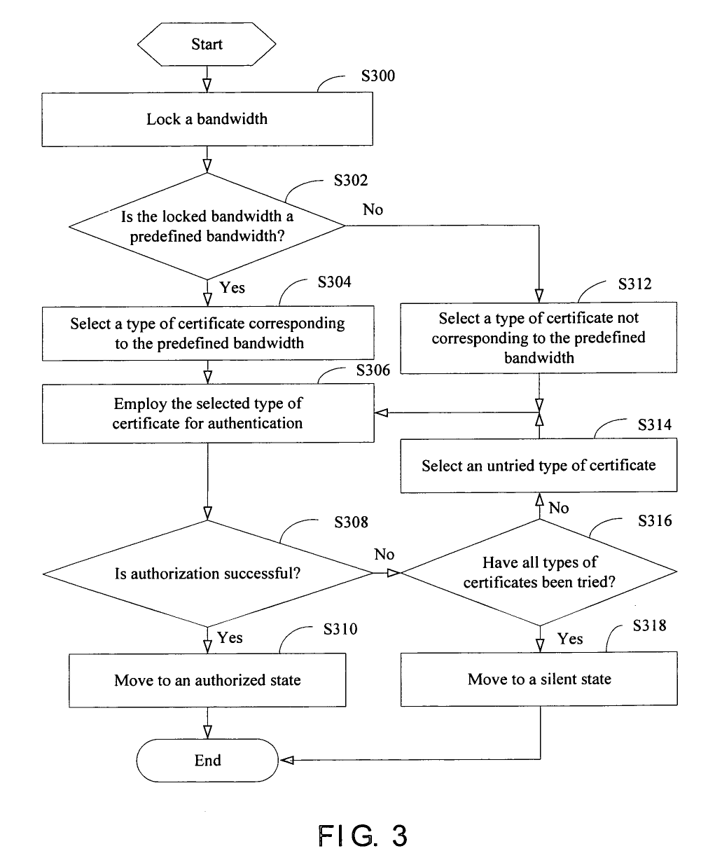

FIG. 3 is a flowchart of a certificate selection method of an exemplary embodiment of the present invention.

In step S300, the locking module 100 locks an attribute of a channel, for example, a bandwidth of the channel by scanning the channel.

In step S302, the frequency selection module 220 determines whether the locked bandwidth is a predefined bandwidth.

If the locked bandwidth is the predefined bandwidth, in step S304, the bandwidth selection module selects a type of certificate corresponding to the predefined bandwidth from a plurality of types of certificates.

In step S306, the authentication module 300 employs the selected type of certificate for authentication.

In step S308, the authentication module 300 determines whether authorization is successful.

If the authorization is successful, in step S310, the modem 10 moves an authorized state.

If the authorization is unsuccessful, in step S316, the switching module 230 determines whether all types of certificates have been tried.

If all types of certificates have been tried, in step S318, the modem 10 moves to a silent state.

If a type of certificate is untried, in step S314, the switching module 230 selects the untried type of certificate. Then going back to step S306, the authentication module 300 employs the type of certificate selected by the switching module 230 for authentication again, until the authorization is successful or all types of certificates have been tried.

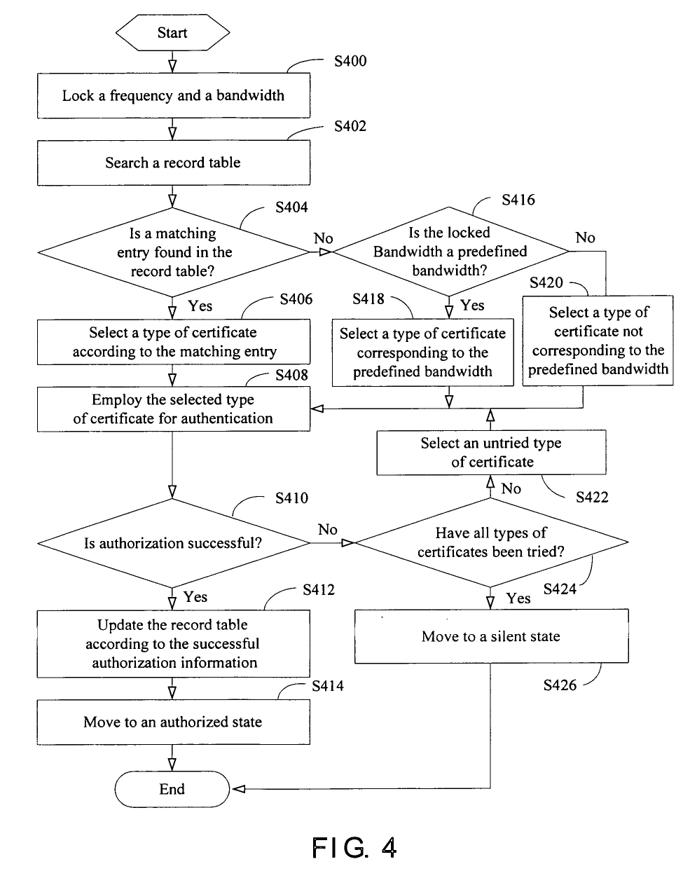

FIG. 4 is a flowchart of a certificate selection method of another exemplary embodiment of the present invention.

In step S400, the locking module 100 locks a frequency and a bandwidth. In the exemplary embodiment, the locking module 100 locks the frequency and the bandwidth by locking a downstream signal.

In step S402, the history selection module 210 searches the record table 211 according to the frequency and the bandwidth locked by the locking module 100.

In step S404, the history selection module 210 determines whether a matching entry is found in the record table 211. In the exemplary embodiment, the history selection module 210 compares the locked frequency and the locked bandwidth with each entry in the record table 211 to determine whether a matching entry is found. If an entry with a frequency and a bandwidth the same as the locked frequency and the locked bandwidth is found in the record table 211, a matching entry is considered found. If no entry with a frequency and a bandwidth the same as the locked frequency and the locked bandwidth is found in the record table 211, then no matching entry has been found.

If a matching entry is found, in step S406, the history selection module 210 selects a type of certificate according to the matching entry, namely according to the certificate field of the matching entry.

If no matching entry is found, in step S416, the bandwidth selection module 220 determines whether the locked bandwidth is a predefined bandwidth.

If the locked bandwidth is the predefined bandwidth, in step S418, the bandwidth selection module 220 selects a type of certificate corresponding to the predefined bandwidth.

If the locked bandwidth is not the predefined bandwidth, in step S420, the bandwidth selection module 220 selects a type of certificate not corresponding to the predefined bandwidth.

In the exemplary embodiment, if the predefined bandwidth is 6 MHz, the type of certificate corresponding to the predefined bandwidth is a US certificate, and the type of certificate not corresponding to the predefined bandwidth is a Euro certificate. If the predefined bandwidth is 8 MHz, the type of certificate corresponding to the predefined bandwidth is a Euro certificate, and the type of certificate not corresponding to the predefined bandwidth is a US certificate.

In step S408, the authentication module 300 employs the type of certificate selected by the history selection module 210 or the bandwidth selection module 230 for authentication. In the exemplary embodiment, the authentication module 300 transmits an authorization request packet to the CMTS 20. The authorization request packet includes the selected type of certificate.

In step S410, the authentication module 300 determines whether authorization is successful. In the exemplary embodiment, the authentication module 300 determines whether the authorization is successful according to a response packet received from the CMTS 20. If receiving an authorization reply packet from the CMTS 20, the authentication module 300 determines the authorization is successful. If receiving an authorization reject packet from the CMTS 20, the authentication module 300 determines the authorization is unsuccessful.

If the authorization is successful, in step S412, the history selection module 210 updates the record table 211 according to the successful authorization information.

In step S414, the modem 10 moves to a BPI authorized state.

If the authorization is unsuccessful, in step S424, the switching module 230 determines whether all types of certificates have been tried.

If all types of certificates have been tried, in step S426, the modem 10 moves to a BPI silent state.

If a type of certificate is untried, in step S422, the switching module 230 selects the untried type of certificate.

Then going back to step S408, the authentication module 300 employs the type of certificate selected by the switching module 230 for authentication again, until the authorization is successful or all types of certificates have been tried.

In the exemplary embodiment of the present invention, the modem 10 automatically and simply selects an appropriate type of certificate according to the locked bandwidth, and then employs the selected type of certificate for authentication, thereby maintaining communication security.

In addition, the modem 10 automatically and simply selects an appropriate type of certificate by searching the record table 211, and employs the selected type of certificate for authentication.

While various embodiments and methods of the present invention have been described above, it should be understood that they have been presented by way of example only and not by way of limitation. Thus the breadth and scope of the present invention should not be limited by the above-described exemplary embodiments, but should be defined in accordance with the following claims and their equivalents.

What is claimed is:

1. A modem, comprising:
a locking module, for locking a bandwidth;
a bandwidth selection module, for determining whether the locked bandwidth is a predefined bandwidth, and selecting a type of certificate from a plurality of types of certificates according to the determined result; and
an authentication module, for employing the selected type of certificate for authentication.

2. The modem as claimed in claim 1, wherein the modem is a cable modem, and the authentication module is for employing the selected type of certificate for baseline privacy interface (BPI) authentication.

3. The modem as claimed in claim 1, wherein the authentication module is also for determining whether authorization is successful.

4. The modem as claimed in claim 3, wherein the authentication module transmits an authorization request packet to a cable modem terminal system (CMTS) for authentication, and determines whether the authorization is successful according to a response packet from the CMTS; the authorization request packet comprises the selected type of certificate.

5. The modem as claimed in claim 3, further comprising a switching module, for determining whether all types of certificates have been tried when the authorization is unsuccessful, and selecting an untried type of certificate.

6. The modem as claimed in claim 5, wherein the modem comprises a record table comprising a plurality of entries of previously successful authorizations, and each entry comprises a frequency field, a bandwidth field, and a certificate field; the frequency field indicates a previously locked frequency, the bandwidth field indicates a previously locked bandwidth, and the certificate field indicates a previously selected certificate.

7. The modem as claimed in claim 6, wherein the locking module is also for locking a frequency.

8. The modem as claimed in claim 7, further comprising a history selection module, for searching the record table according to the locked frequency and the locked bandwidth, and determining whether a matching entry is found in the record table, and also selecting a type of certificate from the plurality of types of certificates according to the matching entry.

9. The modem as claimed in claim 7, wherein the locking module locks the frequency and the bandwidth by locking a downstream signal.

10. The modem as claimed in claim 1, wherein the bandwidth selection module selects a type of certificate corresponding to the predefined bandwidth when the locked bandwidth is the predefined bandwidth, and selects a type of certificate not corresponding to the predefined bandwidth when the locked bandwidth is not the predefined bandwidth.

11. A certificate selection method, comprising:
locking a bandwidth of a channel;
determining whether the locked bandwidth is a predefined bandwidth; and
selecting a type of certificate corresponding to the predefined bandwidth from a plurality of types of certificates if the locked bandwidth is the predefined bandwidth.

12. The certificate selection method as claimed in claim 11, further comprising:
selecting a type of certificate not corresponding the predefined bandwidth from the plurality of types of certificates if the locked bandwidth is not the predefined bandwidth.

13. The certificate selection method as claimed in claim 12, wherein when the predefined bandwidth is 6 MHz, the type of certificate corresponding to the predefined bandwidth is a United States (US) certificate, and the type of certificate not corresponding to the predefined bandwidth is a European (Euro) certificate.

14. The certificate selection method as claimed in claim 12, wherein when the predefined bandwidth is 8 MHz, the type of certificate corresponding to the predefined bandwidth is a Euro certificate, and the type of certificate not corresponding to the predefined bandwidth is a US certificate.

15. The certificate selection method as claimed in claim 12, further comprising:
employing the selected type of certificate for authentication;
determining whether authorization is successful;
determining whether all types of certificates have been tried if the authorization is unsuccessful; and
selecting an untried type of certificate if the type of certificate is not tried.

16. The certificate selection method as claimed in claim 15, further comprising:
providing a record table comprising a plurality of entries of previously successful authorizations, wherein each entry comprises a frequency field, a bandwidth field, and a certificate field, the frequency field indicates a previously locked frequency, the bandwidth field indicates a previously locked bandwidth, and the certificate field indicates a previously selected certificate.

17. The certificate selection method as claimed in claim 16, further comprising:
locking a frequency;
searching the record table according to the locked frequency and the locked bandwidth;
determining whether a matching entry is found in the record table; and
selecting a type of certificate from the plurality of types of certificates according to the matching entry.

18. The certificate selection method as claimed in claim 16, further comprising:
updating the record table according to the successful authorization information if the authorization is successful.

19. A method for selecting operation certificates to operate a data communication device, comprising steps of:
locking an attribute of a channel signally communicable with a data communication device which is operable by adopting a selective one of at least two operation certificates for said data communication device;
selecting one of said at least two certificates corresponding to a predefined attribute for adopting said one of said at least two certificates to operate said data communication device when said locked attribute of said channel matches said predefined attribute; and
switching to another of said at least two certificates to operate said data communication device when said data communication device fails to signally communicate through said channel by adopting said one of said at least two certificates.

20. The method as claimed in claim 19, further comprising a step of establishing a record table comprising a plurality of entries of previously successful communication of said data communication device, and directly using one of said plurality of entries to select from said at least two certificates when said locked attribute of said channel matches said one of said plurality of entries.
